(19) United States
(12) Patent Application Publication
(10) Pub. No.: US 2015/0074274 A1
(43) Pub. Date: Mar. 12, 2015

(54) MULTIPLE DEVICES AND A METHOD FOR ACCESSING CONTENT USING THE SAME

(71) Applicant: Seungil KIM, Seoul (KR)

(72) Inventor: Seungil KIM, Seoul (KR)

(21) Appl. No.: 14/484,291

(22) Filed: Sep. 12, 2014

(30) Foreign Application Priority Data
Sep. 12, 2013 (KR) 10-2013-0109718

(51) Int. Cl. H04L 12/911

(52) U.S. Cl. CPC H04L 47/70
USPC 709/225

(57) ABSTRACT

A method for accessing content through multiple devices is provided. The method for accessing content comprises accessing content of a content provider on a network; transmitting access condition information of the digital device to the content provider, including identification data and network access information of the digital devices; obtaining the operational mode information, which represents at least one operation to be performed by the digital device and assigned based on the access condition information; and providing the operation interface for the digital devices on the content based on the operational mode information.

This application claims priority to and the benefit of Korean Patent Application No. 10-2013-0109718, filed on Sep. 12, 2013, which is hereby incorporated by reference as if fully set forth herein.

### BACKGROUND OF THE INVENTION

1. Field of the Invention

The present invention relates to multiple devices and a method for accessing content using the same, and more particularly, to multiple devices enabling simultaneous input/output operations on identical content and a method for accessing content by using the multiple devices.

2. Discussion of the Related Art

A digital device represents various forms of devices that are capable of processing digital data and performing corresponding operations. With the improved performance of such digital devices, digital devices are capable of executing various types of multimedia content.

Generally, content has been executed through one device. For example, content was saved through one digital device and was executed through the digital device, or content was stored on a server and was executed by digital devices accessing the server. In traditional methods for accessing content, while a specific device executes content, the access of other devices to the identical content was interrupted.

However, with recent proliferation of cloud computing, methods for accessing identical content through multiple devices simultaneously are enabled. Cloud computing is a technology to store various forms of data, including image files, documents, or video files, on a main server in a network, and to download or upload the data through personal digital devices whenever necessary. Users, if necessary, are able to use storage of a central server, which may exist in intangible forms like clouds.

With such development of cloud computing, there may occur a situation that multiple digital devices in different environments may access identical content simultaneously. Therefore, methods enabling digital devices in systematic interoperation mode to perform input/output operations simultaneously on the identical content are required.

### SUMMARY OF THE INVENTION

The present invention aims to enable multiple devices perform input/output operations on identical content efficiently.

To solve the challenges, a method for accessing the content through the multiple devices according to embodiments of the present invention comprises steps of accessing content of a content provider on a network through a digital device; transmitting access condition information of the digital device, including device identification information of the digital device and network access information of the digital device, to the content provider; obtaining information on operational modes, which represent at least one operation to be performed by the digital device based on the access condition information; and providing an operation interface for the content to the digital device based on the information of the operational mode.

Further, the method for providing the content to the multiple devices according to the embodiments of the present invention comprises receiving the access condition information of at least one digital device, including the device identification information of the digital device and the network access information of the digital device; assigning the operational mode to the digital device, which is at least one of a content input mode and an content output mode; receiving an input command from the digital device assigned with the input mode; controlling the content based on the input command; and transmitting results of the content control to a digital device assigned with the output mode.

The digital device according to the embodiments of the present invention comprises a processor controlling the operation of the digital device; and a communication unit transmitting/receiving data based on commands from the processor, which enables the digital device to access the content of the content provider on the network, transmits the access condition information of the digital device to the content provider, including the device identification information of the digital device and the network access information of the digital device, obtains information on operational modes, which represent at least one operation to be performed through the digital device and are assigned based on the access condition information, and provides the operation interface for the content to the digital device based on the information on the operational mode.

According to the embodiments of the present invention, an efficient environment for the content operation may be implemented by distributing input/output means for the identical content to the multiple digital devices.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a drawing illustrating a content providing system according to an embodiment of the present invention.

FIG. 2 is a block diagram illustrating a digital device according to one embodiment of the present invention.

FIG. 3 is a flowchart illustrating a method for accessing content through the digital device according to an embodiment of the present invention.

FIG. 4 is a flowchart illustrating a method for providing the content to the digital device according to an embodiment of the present invention.

FIG. 5 is a flowchart illustrating one embodiment of multiple digital devices accessing the identical content of the content provider and performing input/output operations on the corresponding content.

FIGS. 6 to 10 are drawings illustrating specific embodiments of accessing the content of the content provider through the multiple digital devices and of providing the content to each of the digital devices according to embodiments of the present invention.

### DETAILED DESCRIPTION OF THE INVENTION

For terms used in the present description, widely used current general terms were selected by considering functions of the present invention, but terms may vary according to intention of those skilled in the art, usual practices, or introduction of new technologies. Some of the terms mentioned in the description of the present invention may have been selected by the applicant at his or her discretion, and in such cases the detailed meanings thereof will be described in relevant parts of the description herein. Thus, the terms used in the present description should be interpreted based on substantial meanings of the terms and the whole content of the present description rather than their simple names or meanings.

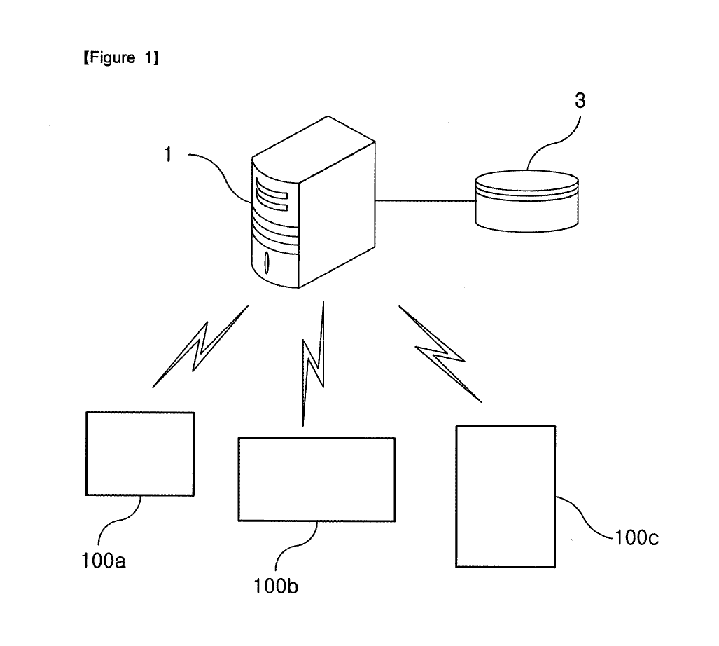

FIG. 1 is a drawing illustrating a content providing system according to an embodiment of the present invention. As shown in the drawing, the content providing system comprises a server 1 providing content and at least one of digital devices 100a, 100b, and 100c, which are connected to the sever 1 through a wired or wireless network.

First, according to the embodiment of the present invention, the server 1 includes a web server, a file server, a cloud, and various forms of other content providing means. The digital device 100 of the present invention may access the content on the server 1 through the wired/wireless network. According to one embodiment, the server 1 is equipped with additional DB 3 to store data including the content, and is capable of providing the data stored on the DB 3 to the digital device 100, if requested by the corresponding digital device 100.

Second, according to the embodiment of the present invention, the digital device 100 includes various devices that may be used as input and/or output means on the content. For example, the digital device 100 may include a television set, a smart phone, a PDA (Personal Digital Assistant), a notebook, a tablet PC, an audio player, a speaker unit, etc., which are capable of outputting display or audio of the content. Further, the digital device 100 may include input means such as a keyboard, a mouse, a touchpad, a microphone, a camera, and various sensor units. Therefore, the digital device 100 according to the present invention includes various means that are capable of communicating with the server 1 through a mounted communication unit (not shown in drawings) and of performing the input/output operations on the content through the unit.

According to the embodiment of the present invention, when the digital device 100 accesses the content on the server 1, the server 1 may assign a specific operational mode on the content to the corresponding digital device 100. The operational mode indicates at least one of the input/output modes on the content, and may include at least one of various input/output modes, which will be described later. According to the embodiment of the present invention, multiple digital devices 100a, 100b, and 100c is capable of accessing the identical content on the server 1, and the server 1 may assign different operational modes to each of the digital devices 100a, 100b, and 100c, respectively. Detailed embodiments thereof will be described later.

In the present invention, the network enabling the data communication between the server 1 and each of digital devices 100a, 100b, and 100c may include various forms of wired/wireless networks. In this case, available wireless networks include Near Field Communication (NFC), ZigBee, infrared communication, Bluetooth, Wi-Fi communication, etc., but the present invention is not limited thereto.

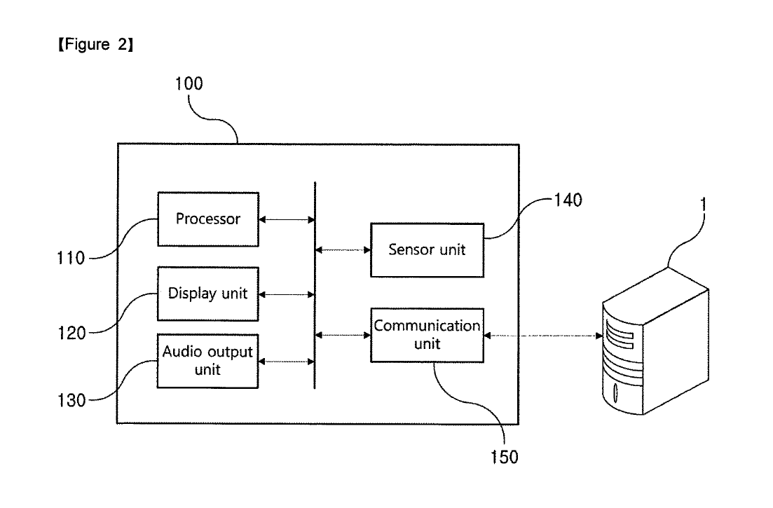

FIG. 2 is a block diagram illustrating the digital device 100 according to an embodiment of the present invention.

As shown in the drawing, the digital device 100 may include a processor 110, a display unit 120, an audio output unit 130, a sensor unit 140, and a communication unit 150.

First, the display unit 120 outputs images on a display screen. The display unit 120 is capable of outputting various display objects including the content executed by the processor 110 or a user interface based on control commands of the processor 110. According to the embodiment of the present invention, when the digital device 100 accesses the content on the server 1, the display unit 120 is capable of outputting images of the corresponding content. According to the embodiment of the present invention, the display unit 120 may be mounted selectively on the digital device 100. If the digital device 100 is equipped with the display unit 120, the server 1 is capable of assigning a display output mode for the content as the operational mode of the corresponding digital device 100. The digital device 100 assigned with the display output mode may receive display data of the content from the server 1 through the communication unit 150, and may output the display data to the display unit 120.

Next, the audio output unit 130 includes various audio output means, for example, a speaker, an earphone, etc. The audio output unit 130 is capable of outputting an audio signal of the content executed by the processor 110, or of outputting a voice based on the control commands from the processor 110. According to the embodiment of the present invention, when the digital device 100 accesses the content on the server 1, the audio output unit 130 is capable of outputting the audio signal of the corresponding content. According to the embodiment of the present invention, the audio output unit 130 may be mounted selectively on the digital device 100. If the digital device 100 is equipped with the audio output unit 130, the server 1 may assign an audio output mode for the content as the operational mode of the corresponding digital device 100. The digital device 100 assigned with the audio output mode is capable of receiving the audio signal of the content from the server 1 through the communication unit 150 and outputting the audio signal to the audio output unit 130.

The sensor unit 140 is capable of detecting surrounding environments of the digital device 100 through at least one of sensors mounted on the digital device 100, and of delivering the detected data to the processor 110. Also, the sensor unit 140 is capable of detecting a user's input and of delivering the input data to the processor 110. In this case, the sensor unit 140 may include at least one of the sensing means. As an embodiment, at least one of the sensing devices may include a gravity sensor, a geomagnetic sensor, a motion sensor, a gyro sensor, an acceleration sensor, an infrared sensor, an inclination sensor, a brightness sensor, an altitude sensor, an odor sensor, a temperature sensor, a depth sensor, a pressure sensor, a bending sensor, an audio sensor, a video sensor, a Global Positioning System (GPS) sensor, a touch sensor, a fingerprint sensor, etc. The sensor unit 140 is a generic term for the various sensing means described above, and is capable of detecting various user inputs and environments of the digital device 100, and of delivering the detected data to the processor 110 so as to enable the processor 110 to perform the corresponding operations. The above-described sensors may be included as individual elements in the digital device 100 or may be included as at least one of integrated elements in the digital device 100.

According to an embodiment of the present invention, the digital device 100 may include various input means, such as a keyboard, a mouse, a touchpad, a microphone, and a camera, etc. When the digital device 100 accesses the content of the server 1 in accordance with the embodiment of the present invention, the sensor unit 140 may receive user's input commands on the corresponding content. According to an embodiment of the present invention, the digital device 100 may be selectively equipped with the sensor unit 140. If the digital device 100 is equipped with the sensor unit 140, the server 1 may assign the input mode for the content as the operational mode of the corresponding digital device 100. The digital device 100 assigned with the input mode is capable of receiving the input command from a user through the sensor unit 140 and transmitting the input command to the server 1 through the communication unit 150.

Next, the communication unit 150 is capable of transmitting/receiving the data by performing communication with an external device or the server 1 by using various protocols. In the present invention, the communication unit 150 is capable of accessing the server 1 or the cloud through a network, and of transmitting/receiving the digital data, for example, the input/output data of the content on the server 1.

The processor 110 of the present invention is capable of executing various forms of the content or applications and processing internal data of the digital device 100. Additionally, the processor 110 is capable of controlling the above described units of the digital device 100 and controlling the data transmission/reception among the units.

The digital device 100 illustrated in FIG. 2 is a block diagram according to one embodiment of the present invention, where separate blocks are illustrated as logically distinguished elements of the device. Accordingly, the elements of the above described device may be mounted in a single chip or in multiple chips, depending on design of the device.

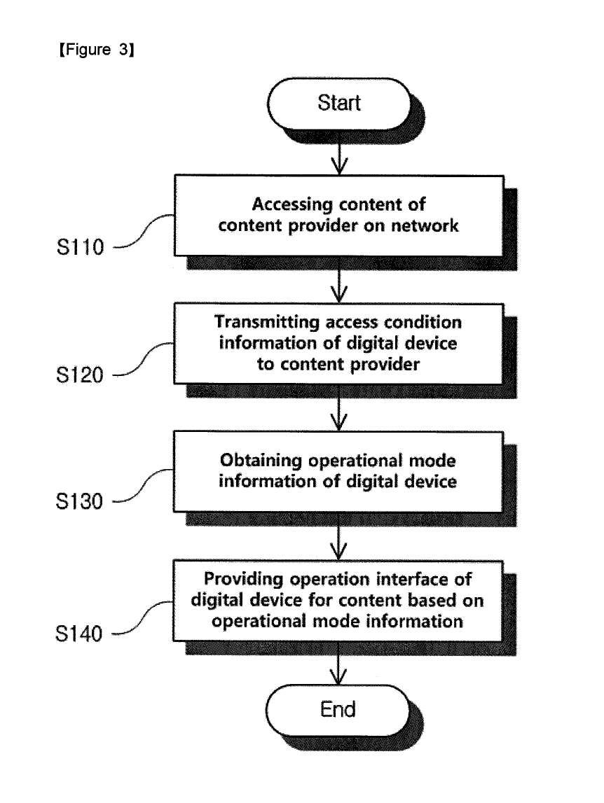

FIG. 3 is a flowchart illustrating a method for accessing content through the digital device according to an embodiment of the present invention. Each step of FIG. 3 described below may be performed by the digital device of the present invention. For example, the processor 110 of the digital device 100 illustrated in FIG. 2 is capable of controlling each step of FIG. 3.

First, the digital device of the present invention is capable of accessing the content of the content provider on the network (S110). In the present description, the content provider is a generic term indicating a web server, a file server, a cloud server, and various forms of other content providing means. The content provider may be equipped with an additional DB to store data including the content, and may be used as a broad concept that includes such DB. Also, the content may include various forms of multimedia content, such as web pages, electronic documents, games, pictures, and videos, and the present invention is not limited thereto. The digital device may access the content provider, for example the server, through the network. According to one embodiment, the digital device may log on to the content provider by using an account of a specific user. After logging on, the user may select or execute the specific content among the multiple content under the user's account. The digital device is capable of accessing the selected or executed content.

According to another embodiment of the present invention, the digital device is capable of accessing the content of the content provider without logging on the corresponding content provider by using a specific account. The digital device may access the content provider in various ways, for example, accessing a specific URL, and the content provider may provide the content to the digital device based on the access condition information of the accessing digital device, including network access information. For example, if multiple digital devices access the content provider through an identical access point or access points classified as an identical group, the content provider may provide the identical content to the corresponding digital devices. However, operational modes assigned to each digital device may be identical or not.

Next, the digital device of the present invention is capable of transmitting the access condition information of the corresponding digital device to the content provider (S120). According to the embodiment of the present invention, the access condition information includes device identification information of the digital device and network access information of the digital device. The device identification information may represent product information of the digital device, and may include additional information indicating whether the device is equipped with one of the units illustrated in FIG. 2 (for example, the display unit, the audio output unit, the sensor unit) according to the embodiment. Meanwhile, the network access information may include information on the access point through which the digital device accessed the network, information on the access time at which the digital device accessed the network, etc. In addition, according to another embodiment of the present invention, the access condition information transmitted to the content provider may include operational mode information of the digital device, which is set on the digital device.

Next, the digital device of the present invention may obtain operational mode information indicating at least one operation to be performed by the digital device (S130). The operational mode in embodiment of the present invention may indicate at least one of the input/output modes for the content. More specifically, the input mode may include a keyboard input mode, a mouse input mode, a touch input mode, a voice input modes, a gesture input modes, an image input mode, and a sensor input mode, and may include the input modes of various means that are capable of performing the input operation on the content. The output mode may include a display output mode and an audio output mode, but, the modes don't limit the present invention.

According to the embodiment of the present invention, the operational mode may be assigned based on the access condition information of the digital device. In other words, the operational mode of the digital device may be determined based on at least one of the device identification information of the digital device and the network access information of the digital device.

According to one embodiment of the present invention, the network access information of the digital device may include the information on time when the digital device accessed the content, and the operational mode may be determined based on the access sequence of the corresponding digital device among at least one of digital devices that accessed the content. For example, if two digital devices accessed the content of the content provider in sequence, the output mode may be assigned to the digital device accessing the content in advance, and the input mode may be assigned to the digital device accessing later.

According to another embodiment of the present invention, the network access information of the digital device may include the information such as the access point or the network address through which the digital device performed the access, or SSID (Service Set Identifier). According to the present invention, the operational mode of the digital device may be assigned based on whether there is any other digital device accessing the content through the identical access point (or, network address, SSID), or an access point classified as identical group with the access point (or, network address, SSID) through which the digital device performed the access. For example, if only one digital device is accessing the content through the identical access point, both of the input mode and the output mode may be assigned to the corresponding digital devices. However, if two or more digital devices are accessing the content through the identical access point, different operational modes may be assigned to each of the digital devices, respectively. According to another embodiment, when the multiple digital devices are accessing the content through different access points respectively, the operational modes of each digital device may be assigned independently. However, when multiple digital devices are accessing the content through one identical access point, the operational mode of each digital device may be assigned in an interoperable way to each other. If two or more digital devices are accessing the identical content through one identical access point, it is assumed that the digital devices are relatively adjacent to each other, and are used by the user(s).

According to another embodiment of the present invention, when the digital device has accessed the content through a predefined access point, the operational mode in the embodiment of the present invention may be assigned to the digital device. According to the embodiment of the present invention, specific places or meeting rooms may be equipped with the predefined access point in order to distribute different operational modes on the identical content to multiple digital devices. Therefore, the digital device accessing the content of the content provider through the predefined access point may be assigned with the operational mode according to the embodiment of the present invention.

According to another embodiment of the present invention, the operational mode may be determined based on the device identification information of the digital device. As described above, the device identification information may include product information of the corresponding digital device, or the information regarding what input/output devices is mounted on the digital device. If the digital device accessing the content is equipped only with the input mean (i.e., a keyboard, a mouse, a touchpad, a microphone, a camera, or various sensor units), the input mode may be assigned as the operational mode with priority for the digital device. Similarly, if the digital device accessing the content is equipped only with output means (i.e., a display unit, an audio output unit), the output mode may be assigned as the operational mode with priority for the digital device. By assigning the operational mode based on the input/output means the accessing digital device is equipped with, the input/output mean on the content may be distributed efficiently.

Meanwhile, according to another embodiment of the present invention, the operational mode of the digital device may be set directly on the corresponding digital device. For example, a user by himself/herself may select whether the digital device will be used as the input mean and/or as the output mean for the content. Likewise, if the operational mode of the digital device is predefined directly on the digital device, the digital device may transmit the predefined operational mode information to the content provider.

Next, the digital device of the present invention is capable of providing an operation interface on the content for the digital device based on the obtained operational mode information (S140). If the operational mode assigned to the digital device is the content output mode, the digital device may activate the corresponding output mean. Specifically, if the operational mode assigned to the digital device is the display output mode, the digital device may activate the display unit of the digital device, and may provide a separate window to display the content on the display unit. If the operational mode assigned to the digital device is the audio output mode, the digital device is capable of activating the audio output unit, for example, speakers. Likewise, if the operational mode assigned to the digital device is the input mode on the content, the digital device is capable of activating the corresponding input mean. Specifically, if the operational mode assigned to the digital device is the voice input mode on the content, the digital device is capable of activating a microphone unit. Also, if the operational mode assigned to the digital device is the gesture input mode, the digital device is capable of activating a camera unit. If the operational mode assigned to the digital device is the touch input mode, the digital device is capable of receiving the touch signal detected through a mounted touchpad as the input on the content. According to an embodiment of the present invention, at least one output mode and at least one input mode may be assigned together as the operational modes of the digital device, and the digital device may activate the corresponding output means and the corresponding input means together. Besides, the digital device may be equipped with various input/output means, and may activate at least one of the input/output means based on the obtained operational mode information according to the embodiment of the present invention.

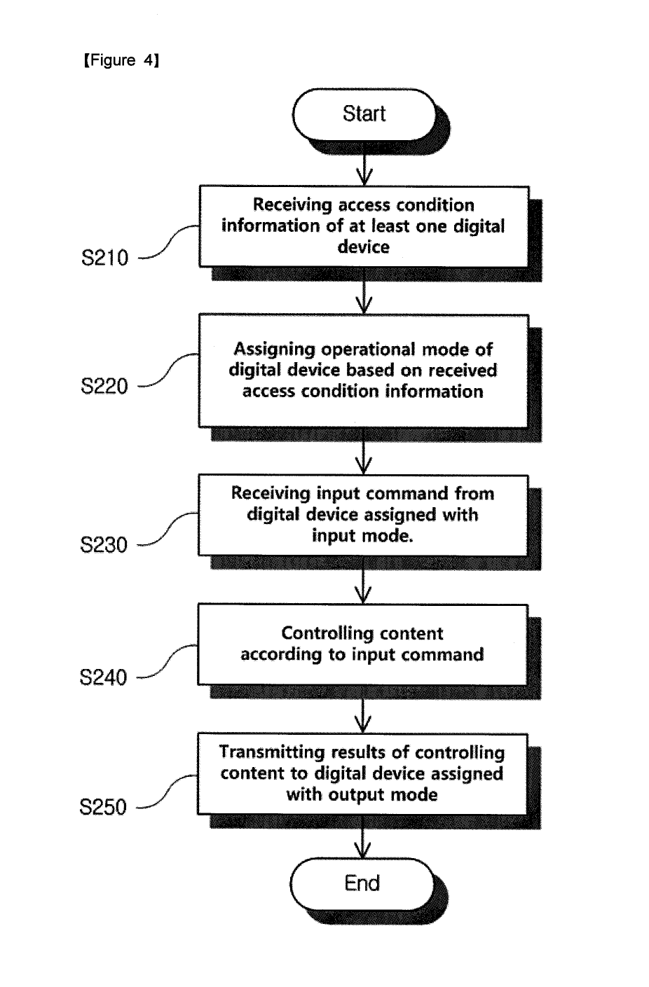

FIG. 4 is a flowchart illustrating the method of the content provider providing the content to the digital device according to an embodiment of the present invention. In the present invention, the content provider is a generic concept indicating a web server, a file server, a cloud server, and various forms of other content providing means, as described above.

First, the content provider of the present invention receives access condition information of at least one digital device (S210). The access condition information includes the device identification information of the digital device and the network access information of the digital device accessing the content provider. As described above, the device identification information may indicate the product information of the digital device, and may include additional information indicating what input/output means the digital device is equipped with, according to an embodiment. Furthermore, the network access information may include the information on the access point through which the digital device accessed the network, the information on time at which the digital device accessed the network, etc. According to another embodiment of the present invention, the access condition information transmitted to the content provider may include the operational mode information of the digital device, which has been designated on the corresponding digital device.

Next, the content provider of the present invention assigns operational mode of the digital device based on the received access condition information (S220). In the present invention, the operational mode represents at least one of the input/output modes for the content. More specifically, the input mode may include the keyboard input mode, the mouse input mode, the touch input mode, the voice input mode, the gesture input mode, the image input mode, and the sensor input mode, and may include various means of input modes that are capable of performing the input operation on the content. The output mode may include the display output mode and the audio output mode, but the present invention is not limited thereto. According to the embodiment of the present invention, the operational mode may be assigned based on the access condition information of the digital devices and specific embodiments of the assignment are described in S130 of FIG. 3.

Likewise, if at least one of the input/output modes on the content is assigned to at least one digital device, the content provider may perform the input/output operation for the content via the corresponding digital devices.

Specifically, the content provider of the present invention is capable of receiving input command from a digital device assigned with input mode (S230). For example, the content provider may receive at least one input among a keyboard input, a mouse input, a touch input, a voice input, a gesture input, an image input, and various forms of other sensor inputs from the corresponding digital device. The input command transmitted by the digital devices may include input operations performed by users, and sensing values detected by the corresponding digital devices.

Next, the content provider of the present invention controls the content based on the input commands (S240). For example, the content provider may modify the content in documents based on the keyboard input received from the digital device. The content provider may insert voices or images into the content based on the corresponding inputs received from digital devices, or execute a predefined interface. In addition, the content provider may perform zoom in/out, deletion, editing, or skipping operations on picture content based on various input commands received from the digital device, and perform various playing and editing operations on video content.

Next, the content provider of the present invention transmits results of controlling the content to a digital device assigned with the output mode (S250). The digital device assigned with the output mode is capable of outputting the received results of the content control. Therefore, a user may confirm the content modified on the above S240 through the digital device assigned with corresponding output modes.

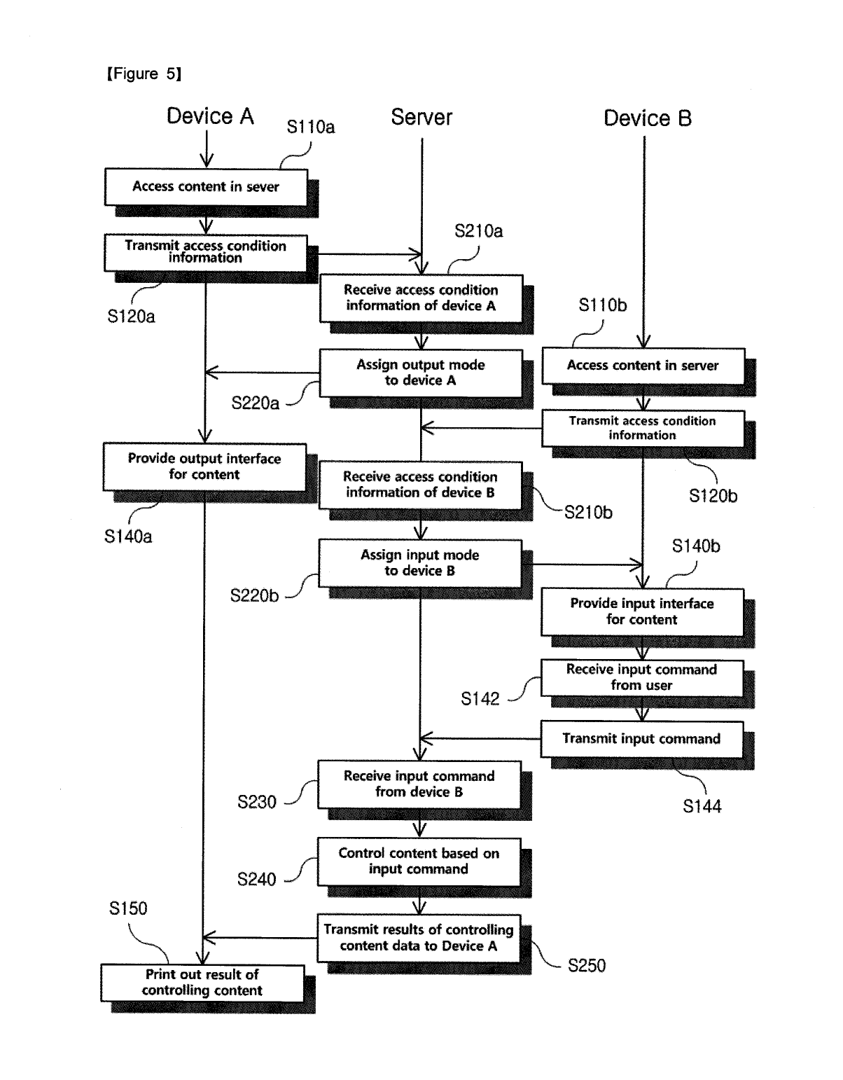

FIG. 5 is a flowchart illustrating one embodiment that multiple digital devices access the identical content of the content providers and perform the input/output operation for the corresponding content. In FIG. 5, device A and device B represent the digital devices according to the embodiment of the present invention, and the server represents the content provider according to the embodiment of the present invention.

In the embodiment of FIG. 5, the operational mode of the digital device may be determined based on the access sequence of the corresponding digital device among at least one of the digital device accessing the content of the content provider. For example, if two digital devices are accessing the content of the content provider in sequence, the output mode may be assigned to the digital device accessing the content in advance, and the input mode may be assigned to the digital device accessing later. In this case, it is assumed that each digital device is equipped with the input/output means corresponding to each of the input and output mode.

Referring to FIG. 5, device A is capable of accessing the content on the server in advance (S110a). The server access includes the access through the wired/wireless network, and may include access by log on to the corresponding server. The specific content of the corresponding server may be executed or selected by device A, through which the access between the corresponding content and device A may be performed. If device A accesses the content on the server, access condition information of device A is transmitted to the server (S120a). As described above, the access condition information includes device identification information of device A and network access information of device A.

Further, the server receives the access condition information of device A, which is accessing the server (S210a). The operational mode is assigned to device A based on the received access condition information of device A. In the embodiment of FIG. 5, as there is no digital device accessing the content on the corresponding server yet, the server may assign the output mode to device A (S220a). Device A obtains the output mode assigned by the server as an operational mode of the device. Also, device A provides the interface for the output operation on the content based on the obtained operational mode (S140a). If the operational mode assigned to device A is a display output mode, device A is capable of activating a display unit of device and providing a separate window to display the content on the display unit. If the operational mode assigned to device A is an audio output mode, device A is capable of activating an audio output mean, for example, a speaker.

According to the embodiment of FIG. 5, after device A accesses the content on the server, device B may access the content on the server (S110b). If device B accesses the content on the server, the access condition information of device B is transmitted to the server (S120b). A detailed embodiment of S110b and S120b are the same as described in S110a and S120a above.

The server receives the access condition information of device B (S210b). Also, the operational mode is assigned to device B based on the received access condition information of device B. In the embodiment of FIG. 5, as device A is already accessing the content on the server, the server may assign input mode to device B (S220b). Device B obtains the input mode assigned by the server as the operational mode of the device. Device B provides the interface for the input operation on the content based on the obtained operational mode (S140b). If the operational mode assigned to device B is a voice input mode, device B is capable of activating a microphone unit. If the operational mode assigned to device B is a gesture input mode, device B is capable of activating a camera unit. Also, if the operational mode assigned to device B is a touch input mode, device B is capable of receiving touch signals detected through a mounted touchpad as the input on the content. In addition, device B may be equipped with various input devices, and at least one of the input devices may be activated based on the operational modes assigned based on the embodiment of the present invention.

Next, device B may receive the input commands of a user (S142). Device B may receive at least one of the input among the keyboard input, the mouse input, the touch input, the voice input, the gesture input, the image input, and other inputs from various sensors based on assigned input modes. Device B transmits the received input commands to the server (S144).

The server receives the input commands from device B (S230), and controls the content based on the input commands (S240). For example, the server is capable of modifying the content in documents based on the keyboard input received from device B. Also, the server is capable of inserting voices or images into the content based on the corresponding input received from device B, or of executing the predefined interface. In addition, a server is capable of performing zoom in/out, deletion, editing, or skipping operations on the picture content based on the input command received from device B, and perform various execution and edit operations on the video content.

A server transmits data (or result) of the content control operation to device A (S250). Device A is capable of receiving and outputting the data (or result) of content control operation from the server (S150). Device A is capable of outputting the content control data (or result) through the content output interface activated in S140a.

FIG. 5 illustrates one embodiment of assigning the operational mode to each digital device based on the access condition information of the digital device, but it is possible to modify the embodiment in various ways in the present invention.

For example, according to another embodiment of the present invention, both of the input mode and the output mode for the content may be assigned to device A. And, after device B accesses the content on the server, only the content output mode may be assigned to device A. In other words, if only device A accesses the content on the server, device A may be used as the input/output means of the corresponding content, and if device B accesses the content on the server additionally, the input device and the output device on the content may be separated.

Further, the input mode (or, the input/output mode) may be assigned to device A accessing the content on the server in advance, and the output mode may be assigned to device B accessing the content later.

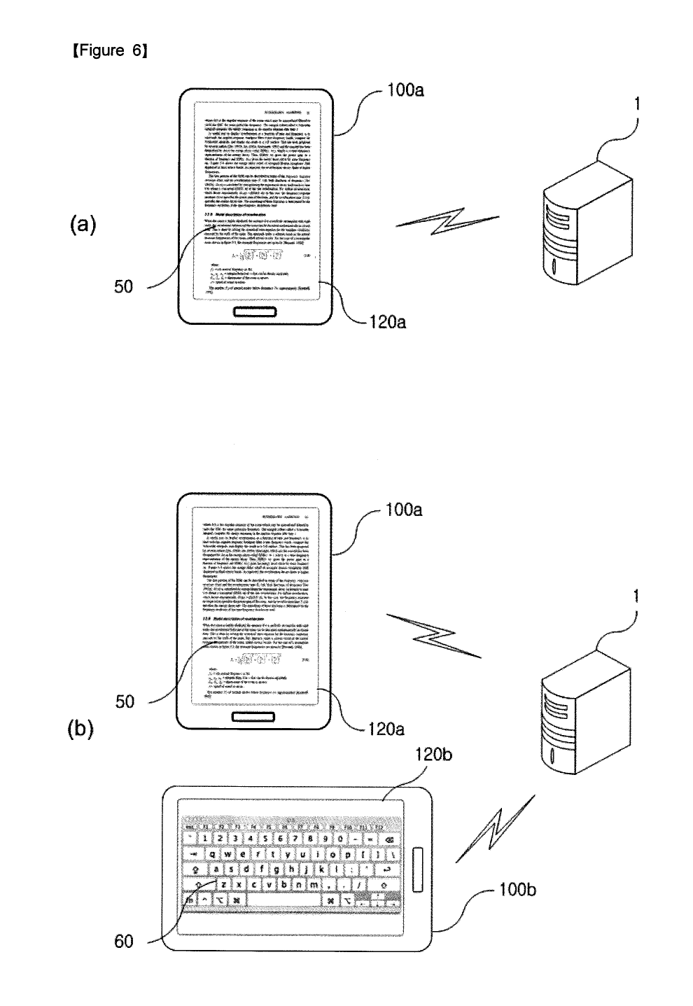

FIGS. 6 to 10 illustrate detailed embodiments of the multiple digital devices accessing the content of the content provider, wherein the content is provided to each digital device according to the embodiment(s) of the present invention.

First, FIG. 6 illustrates the embodiments of determining the operational mode of digital devices 100a and 100b based on the sequence of the digital device 100a and 100b accessing the content of the server 1. As one embodiment of the present invention, the content output mode may be assigned to the digital device accessing the content on the server 1 in advance, and the content input mode may be assigned to the digital device accessing additionally to the content.

Referring to FIG. 6(a), if only the digital device 100a accesses the content on the server 1, the display output mode may be assigned to the digital device 100a. In this case, the digital device 100a is capable of providing a display output interface 50 on a display unit 120a. The display output interface 50 may include a display unit itself activated to display the content, and may include an additional window provided to display the content on a display unit. According to another embodiment of the present invention, if the display unit 120a mounted on the digital device 100a is a touch sensitive display, both of the display output mode and the touch input mode may be assigned to the digital device 100a.

Meanwhile, if a user wants to perform the input operation for the content additionally while watching the display output of the content through the digital device 100a in FIG. 6(a), another digital device accessing the content may be used as the input device.

FIG. 6(b) represents the digital device 100b accessing the content on the server 1 additionally in the embodiment of FIG. 6(a). If the digital device 100b accesses the content on the server 1 additionally while the digital device 100a is accessing the content, the input mode, for example, the keyboard input mode, may be assigned to the digital device 100b. In this case, the digital device 100b may provide a keyboard input interface 60. If the display unit 120a mounted on the digital device 100b is a touch sensitive display, the digital device 100b may provide the keyboard input interface 60 on the display unit 120a. Or, the digital device 100b may be a keyboard equipped with a communication unit. For example, the digital device 100b may be a keyboard equipped with the communication means, such as Bluetooth, NFC (Near Field Communication), infrared communication, Zigbee, or Wi-fi, and is capable of accessing the content on the server 1 by using the communication means. In this case, the digital device 100b is assigned with the content input mode according to the embodiment of the present invention, but with the keyboard input mode based on the device identification information of the digital device 100b.

Likewise, according to the embodiment of the present invention, the input operation and the output operation may be performed for the identical content through different digital devices, respectively. For example, a user performs the input operation for the content through the digital device 100b, and is capable of displaying the content through the digital device 100a. FIG. 6 illustrates the embodiment of assigning the keyboard input mode to the digital device 100b, but the present invention is not limited thereto, as various input modes described above including a mouse input mode, a touch input mode, or a voice input mode may be assigned.

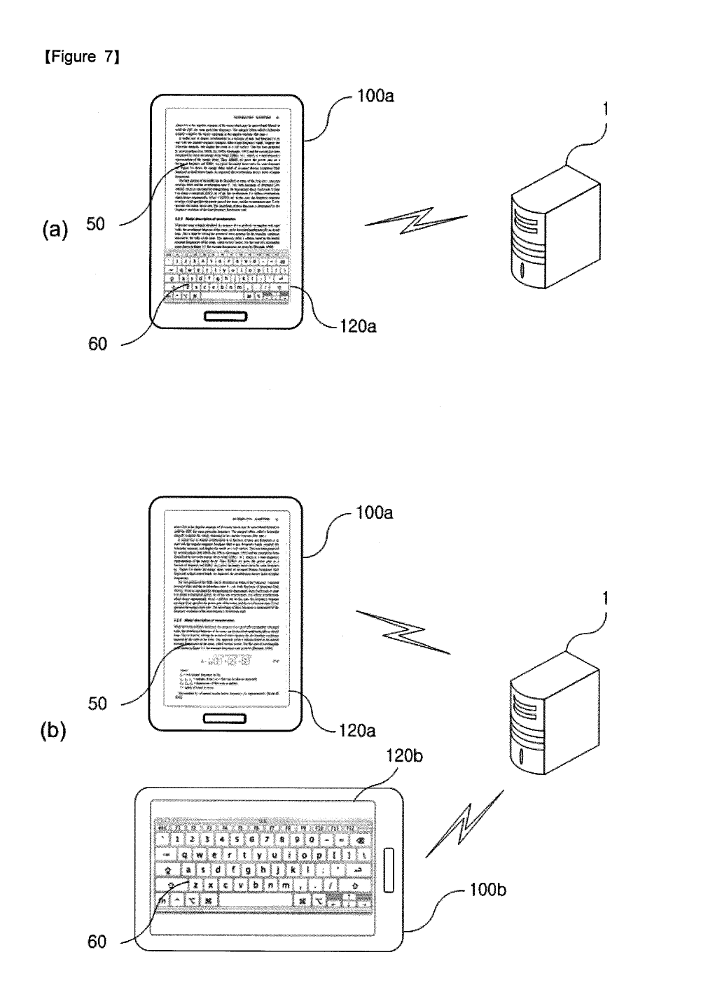

FIG. 7 illustrates another embodiment of determining the operational mode of each digital device 100a and 100b based on the sequence of the access on the content on the server 1. In the embodiment of FIG. 7, the repeated description on the sections identical or corresponding to the embodiment of FIG. 6 will be skipped.

According to an embodiment of FIG. 7, the digital device accessing the content on the server 1 in advance may be assigned with both the output mode and the input mode for the content, and if there is any additional digital device accessing the content, each digital device accessing the content may be assigned with the output mode and the input mode independently.

Referring to FIG. 7(a), if only the digital device 100a accesses the content on the server 1, both of the display output mode and the keyboard input mode may be assigned together to the digital device 100a. In this case, the digital device 100a is capable of providing the display output interface 50 and the keyboard input interface 60 simultaneously on the display unit 120a. It may be desirable that the display unit 120a mounted on the digital device 100a is a touch sensitive display.

Next, as illustrated in FIG. 7(b), if the digital device 100b accesses the content on the server 1 additionally, the display output mode and the keyboard input mode are assigned to the digital devices 100a and 100b, respectively. As described above, the display output mode and the keyboard input mode may be distributed based on the sequence of the content access and the device identification information of each digital device 100a and 100b. For example, according to an embodiment of FIG. 7(b), the display output mode may be assigned to the digital device 100a accessing the content in advance, and the keyboard input mode may be assigned to the digital device 100b accessing the content later. Therefore, the digital device 100a may provide only the display output interface 50 on the display unit 120a, and may not provide the keyboard input interface 60. Also, the digital device 100b accessing the content additionally may provide the keyboard input interface 60. Thus, the content input/output interface provided by the digital device 100a may be distributed to two digital devices, 100a and 100b.

FIG. 7 illustrates one embodiment of distributing multiple input/output modes, which are assigned to the digital device 100a, to the digital devices 100a and 100b, but the present invention is not limited thereto. For example, the digital device 100b may be assigned with at least one mode (for example, the keyboard input mode) among the multiple input/output modes (for example, the display output mode and the keyboard input mode) assigned to the digital device 100a, but the digital device 100a may keep the multiple input/output modes (for example, the display output mode and the keyboard input mode) assigned earlier intact, or may be assigned additionally with a new input/output mode (for example, a touch input mode).

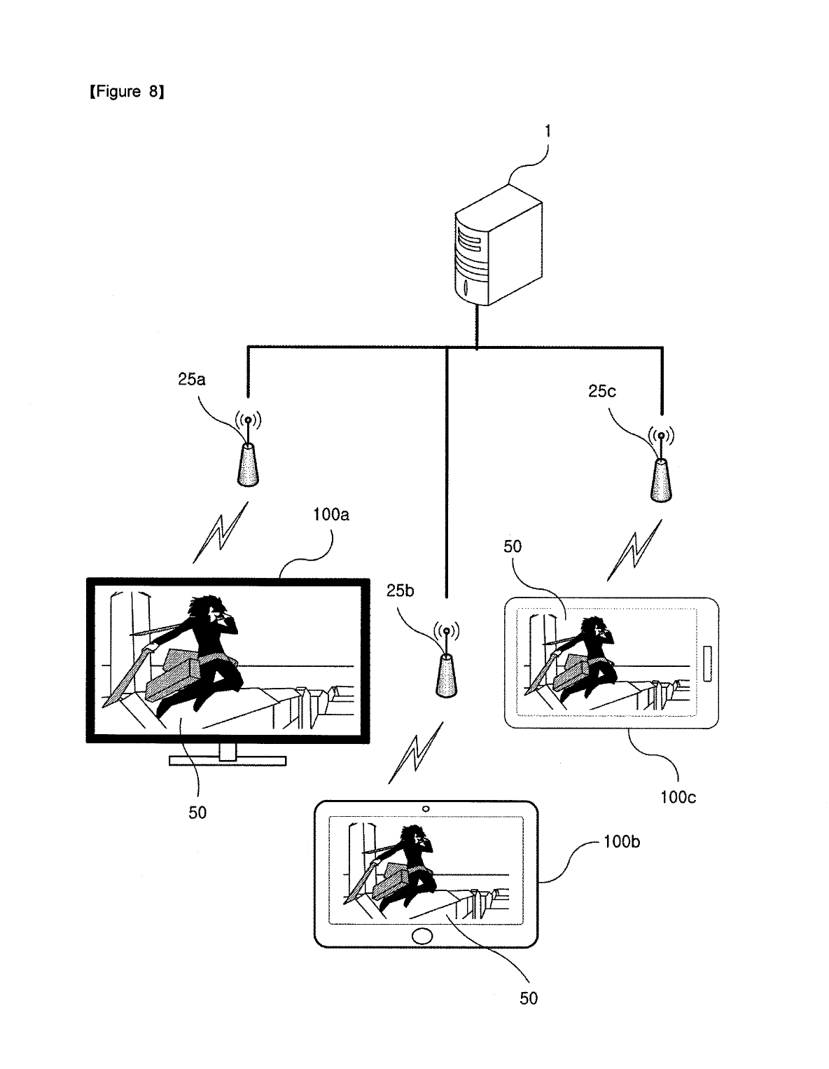

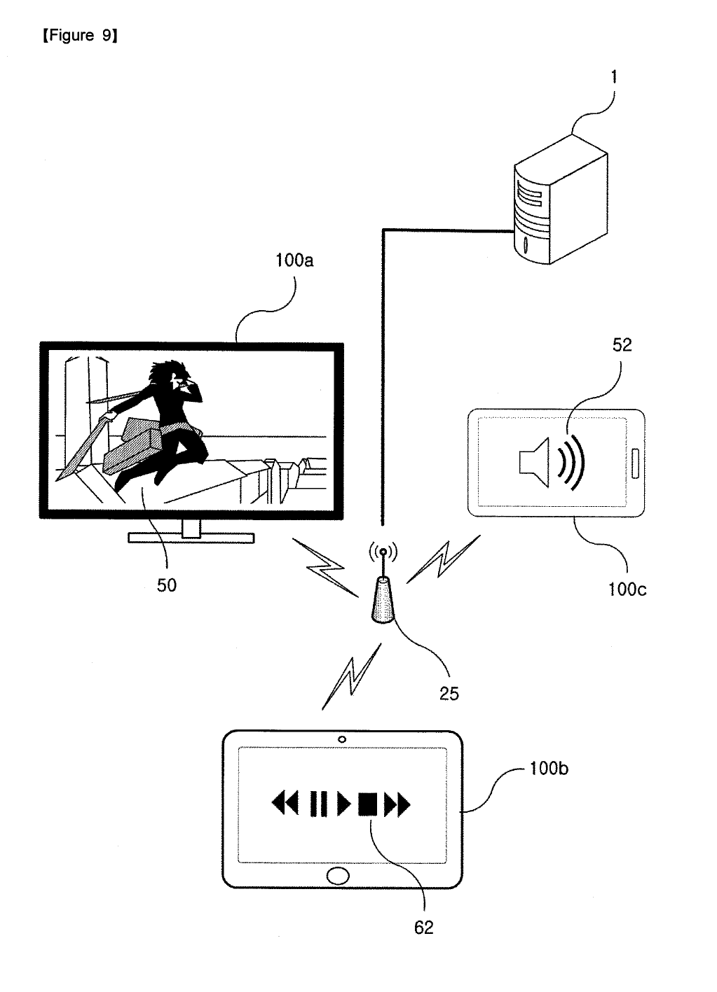

FIGS. 8 and 9 illustrate embodiments of determining the operational modes of the digital devices 100a, 100b, and 100c, respectively, based on the network access information of the digital device 100, specifically based on the data of the access point accessed by each of digital devices 100a, 100b, and 100c. According to one embodiment of the present invention, the operational mode of the digital device 100 may be assigned based on whether there is any other digital device accessing the content through the identical access point 25 to the access point 25 of the digital device 100.

Referring to FIG. 8, the digital devices 100a, 100b, and 100c are accessing the network through the access points 25a, 25b, and 25c, respectively. If each of digital devices 100a, 100b, and 100c accesses the content on the server 1 through the different access points 25a, 25b, and 25c, respectively, the operational mode of each digital device 100a, 100b, and 100c may be assigned independently to each other. For example, as shown in FIG. 8, if each of digital devices 100a, 100b, and 100c is equipped with a display unit, the display output interface 50 may be assigned to each of the digital devices 100a, 100b, and 100c. If there is any device equipped with the input mean among the digital devices 100a, 100b, and 100c, the content input mode may also be assigned to the corresponding digital device. According to one embodiment, the operational modes assigned to each of the digital devices 100a, 100b, and 100c may be assigned based on the device identification information of the corresponding digital device. However, the operational modes in the embodiment of FIG. 8 may be assigned to each of the digital devices 100a, 100b, and 100c, regardless of the operational modes of other digital devices.

Next, FIG. 9 illustrates an embodiment of all of the digital devices 100a, 100b, and 100c accessing a network through one identical access point 25. According to an embodiment of the present invention, if there are two or more digital devices accessing content on the server 1 through the identical access point 25, the operational modes may be assigned to each of the digital devices by considering operational modes of other digital devices.

For example, as shown in FIG. 9, the content input/output modes may be assigned to different digital devices, respectively. For example, the display output mode may be assigned to the digital device 100a, the content replay control mode may be assigned to the digital device 100b, and the audio output mode may be assigned to the digital device 100c, respectively. Based on the assignment, the digital device 100a may provide the display output interface 50, the digital device 100b may provide the content replay control interface 62, and the digital device 100c may provide the audio output interface 52, respectively. Operational modes may be distributed to each of the digital devices 100a, 100b, and 100c based on the content access sequence or the device identification information of each digital device, according to various embodiments of the present invention. In the embodiment of FIG. 9, the digital device 100a may represent TV, the digital device 100b may represent a tablet PC, and the digital device 100c may represent a speaker, respectively. Therefore, a user may be provided with the display output of a video content through TV (digital device 100a), may control the replay of the video content through a tablet pc (digital device 100b), and may be provided with the audio output of the video content through separate speakers (digital device 100c). If there are two or more digital devices accessing the identical content through one identical access point, it is assumed that the digital devices are relatively adjacent to each other, and are used by the user(s). Therefore, in the embodiment of the present invention, only when multiple digital devices 100a, 100b, and 100c access the content, the operational modes of the digital devices 100a, 100b, and 100c may be in the interoperation.

According to another embodiment of the present invention, when the access point of each of the digital devices 100a, 100b, and 100c is the predefined access point, the operational modes of the digital devices 100a, 100b, and 100c may be connected to each other. According to the embodiment of the present invention, a specific place or meeting room may be equipped with the predefined access point in order to distribute different operational modes on the identical content to multiple digital devices 100a, 100b, and 100c. Therefore, digital devices 100a, 100b, and 100c accessing the content on the server 1 through the predefined access point 25 may be assigned with operational modes, according to the embodiment of the present invention.

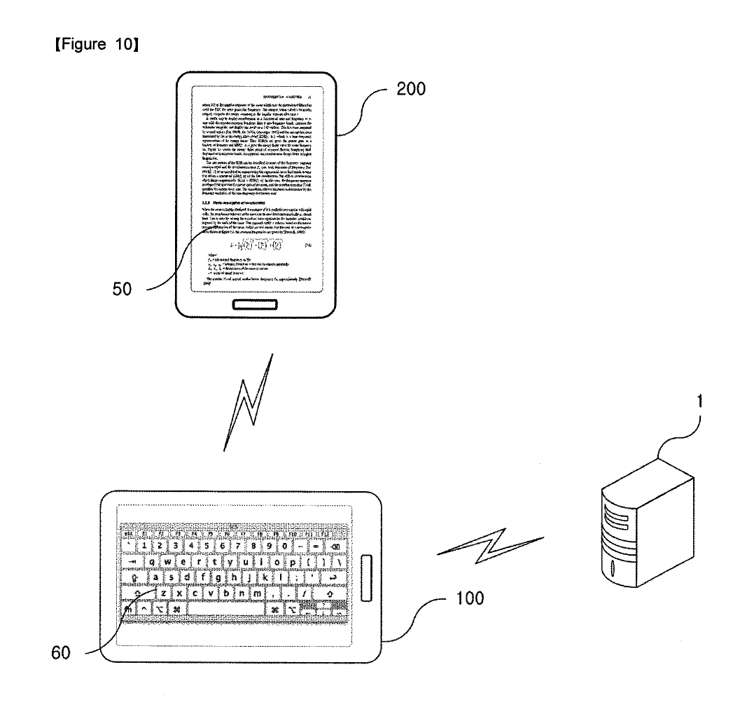

FIG. 10 illustrates a method for accessing the content according to another embodiment of the present invention. According to the embodiment in FIG. 10, a digital device 100 of the present invention may receive the operational mode of an external digital device 200, which is paired with the digital device 100, along with the operational mode of the digital device 100. First, the digital device 100 receives the device identification information of the paired external digital device 200. The device identification information of the external digital device 200 may represent the product information of the external digital device 200, and may include additional information showing what input/output units are mounted on the external digital device 200, according to the embodiment. Next, the digital device 100 may access the content on the server 1 according to the embodiment of the present invention. In this case, the digital device 100 may transmit the access condition information of the digital device 100 and the external digital device 200.

The server 1 may assign the operational mode of the digital device 100 and the external digital device 200, based on the access condition information of the digital device 100 and the external digital device 200. The server 1 is capable of transmitting the information on the operational mode of the digital device 100 and the external digital device 200 to the digital device 100, and the digital device 100 receives the information. The digital device 100 may provide the operation interface based on the transmitted operational mode information of the digital device 100, and the transmitted operational mode information of the external digital device 200 may be transmitted to the paired external digital device 200. The external digital device 200 may provide the operation interface based on the received operational mode information of the external digital device 200.

FIG. 10 illustrates the embodiment where the operational mode of the digital device 100 is assigned as the keyboard input mode and the operational mode of the external digital device 100 is assigned as the display output mode. The digital device 100 may provide the keyboard input interface 60 on the device itself, and the external digital device 200 may provide the display output interface 50. However, in the embodiment of FIG. 10, the access condition information of the external digital device 200 is transmitted to the server 1 through the digital device 100, and the operational mode of the external digital device 200 may be transmitted by the digital device 100 from the server to the external digital device 200. According to another embodiment of the present invention, the operational modes distributed respectively to the digital device 100 and the external digital device 200 may be determined by the digital device 100. For example, the server 1 may transmit at least one of available operational modes to the digital device 100 based on the received access condition information of the multiple digital devices, and the digital device 100 may distribute at least one of the received operational modes to the digital device 100 and the external digital device 200. The operational mode may be distributed based on the device identification information of each digital device, as described in the above embodiment.

In the above description, the present invention is described based on specific embodiments, but those skilled in the art may modify or change them without departing from the spirit and scope of the present invention. Therefore, the results that may be inferred easily from the detailed description and embodiments can be interpreted as falling within the scope of the claims of the present invention.

What is claimed is:

1. A method for accessing content by using multiple devices, comprising:
accessing, by a digital device, the content of a content provider on a network;
transmitting access condition information of the digital device to the content provider, wherein the access condition information includes device identification information of the digital device and network access information of the digital device;
obtaining operational mode information representing at least one operation to be performed by the digital device, wherein the operational mode is assigned based on the access condition information; and
providing an operation interface of the digital device for the content based on information on the operational mode information.

2. The method of claim 1,
wherein the operational mode information represents at least one of input mode for the content and output mode for the content.

3. The method of claim 2,
wherein the input mode includes a keyboard input mode, a mouse input mode, a touch input mode, a voice input mode, a gesture input mode, an image input mode, and a sensor input mode.

4. The method of claim 2,
wherein the output mode includes a display output mode and an audio output mode.

5. The method of claim 1,
wherein the network access information includes information of time at which the digital device accessed the content,
wherein the operational mode is assigned based on an access sequence of the corresponding digital device among at least one digital device accessing the content.

6. The method of claim 1,
wherein the network access information includes information on an access point through which the digital device performed the access,
wherein the operational mode is assigned based on whether there is any other digital device that accessed the content through an identical access point with the access point.

7. The method of claim 1,
wherein the network access information includes information of an access point through which the digital device performed the access,
wherein the operational mode is assigned to the digital device when the access point is a predefined access point.

8. The method of claim 1,
wherein the operational mode is determined based on the device identification information.

9. The method of claim 1,
wherein the access condition information transmitted to the content provider includes operational mode information of the digital device, which has been designated on the corresponding digital device.

10. The method of claim 1, further comprising:
receiving device identification information of an external digital device paired with the digital device,
wherein the transmitting includes transmitting the access condition information of the digital device and access condition information of the external digital device simultaneously.

11. The method of claim 10, further comprising:
transmitting operational mode information of the external device, assigned by the content provider, to the external digital device.

12. A method for providing content to multiple devices, comprising:
receiving access condition information of at least one digital device, wherein the access condition information includes device identification information of the digital device and network access information of the digital device;
assigning operational mode of the digital device based on the received access condition information, wherein the operational mode represents at least one of input mode and output mode for the content;
receiving input commands from a digital device assigned with the input mode;
controlling the content based on the input commands; and
transmitting a result of controlling the content to a digital device assigned with the output mode;

13. A digital device comprising:
a processor configured to control operation of the digital device; and
a communication unit configured to transmit/receive data based on a command of the processor,
wherein the processor is further configured to:
access, by the digital device, content of a content provider on a network;
transmit access condition information of the digital device to the content provider, wherein the access condition information includes device identification information of the digital device and network access information of the digital device;
obtain operational mode information indicating at least one operation to be performed by the digital device, wherein the operational mode is assigned based on the access condition information;
provide an operation interface of the digital device for the content based on the operational mode information.
